(19) United States
(12) Patent Application Publication
(10) Pub. No.: US 2006/0061860 A1
(43) Pub. Date: Mar. 23, 2006

(54) Screen

(76) Inventors: John A. Devos, Corvallis, OR (US); William J. Allen, Corvallis, OR (US); Ravi Prasad, Corvallis, OR (US); Gregory J. May, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/945,661

(22) Filed: Sep. 21, 2004

(51) Int. Cl. G03B 21/56

(52) U.S. Cl. 359/443

(57) ABSTRACT

A screen has an active material, having at least one optical property responsive to an electric field, disposed between electrodes, and a controller coupled to at least one of the electrodes for controlling the electric field in response to a signal received by the controller.

### BACKGROUND

Projection screens display images projected thereon by projectors, which may include a rear projection device or a frontal projection system.

Active screens have been developed that adjust contrast in response to changing ambient or projected lighting conditions. However, the amount of energy used to change the properties of the materials used in some active screens may not practically be available from the projected light for some active screens.

### DESCRIPTION OF THE DRAWINGS

FIG. 1 is a block diagram of an embodiment of a projection system, according to an embodiment of the present disclosure.

FIG. 2 is an enlarged cross-section of a portion of an embodiment of an active projection screen, according to another embodiment of the present disclosure.

FIG. 3 illustrates an embodiment of an active projection screen, according to another embodiment of the present disclosure.

### DETAILED DESCRIPTION

In the following detailed description of the present embodiments, reference is made to the accompanying drawings that form a part hereof, and in which is shown by way of illustration specific embodiments of the present disclosure that may be practiced. These embodiments are described in sufficient detail to enable those skilled in the art to practice the embodiments of the present disclosure, and it is to be understood that other embodiments may be utilized and that process, electrical or mechanical changes may be made without departing from the scope of the present disclosure. The following detailed description is, therefore, not to be taken in a limiting sense, and the scope of the present disclosure is defined only by the appended claims and equivalents thereof.

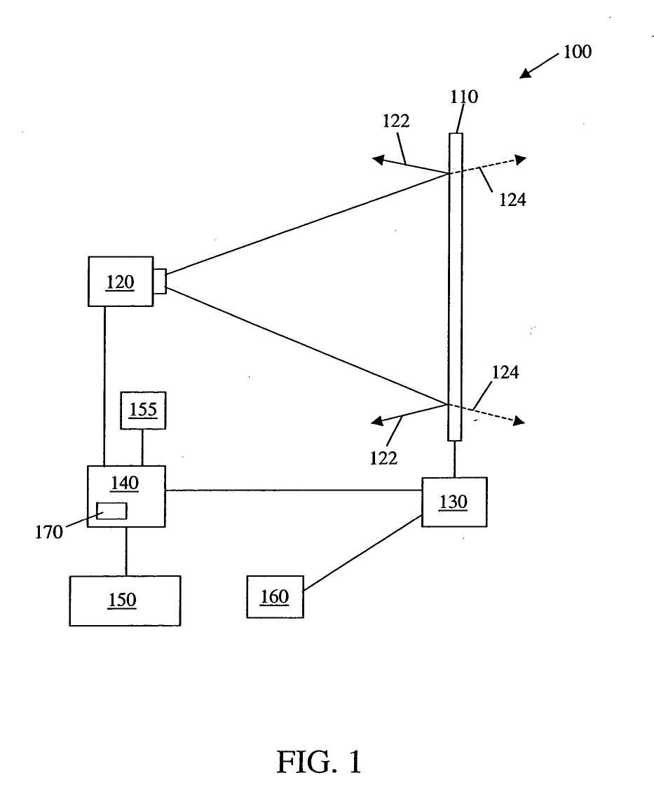

FIG. 1 is a block diagram of a display (or projection) system 100, according to an embodiment of the present disclosure. Other projection system embodiments may be implemented with fewer or additional elements than illustrated in FIG. 1 and/or the functions associated with some of the elements may be integrated within other elements. Projection system 100 includes a screen, such as, in one example embodiment, an active projection screen 110, and a projector 120 for projecting images onto screen 10. For one embodiment, projection system 100 is a frontal projection system, and the images projected onto the screen are reflected by screen 110, as indicated by arrows 122. For another embodiment, projection system 100 is a rear projection system, and the images projected onto the screen are transmitted by screen 110, as indicated by dashed arrows 124.

A screen controller 130, such as a voltage or current switch, is connected to screen 110 for controlling the contrast, color, or the like of screen 110 by controlling the optical properties, such as transmittance, reflectance, absorbance, darkness, etc. of screen 110 in response to control signals received from a main controller 140 connected between the screen controller 130 and projector 120, for one embodiment. For another embodiment, the signal is based at least one of an ambient light level, a property of an image to be projected onto the screen, or content of an image to be projected onto the screen. For some embodiments, optical properties, such as transmittance, reflectance, absorbance, etc. may change significantly with respect to only certain wavelengths of light while remaining substantially unchanged for other wavelengths of light. For other embodiments, optical properties, such as transmittance, reflectance, absorbance, etc. may change significantly for all wavelengths of light. For one embodiment, the control signals may include temperature compensation, e.g., for ambient temperature, etc. For another embodiment, the control signals include voltages or currents and do not include any images to be projected onto screen 110.

Contrast may be defined as a difference between the lightest and darkest areas on a screen, such as screen 110. Contrast ratio is another way of describing the contrast and may be defined as the ratio of the maximum value of the dynamic range of an image to the minimum value of the dynamic range of the image.

For one embodiment, the screen controller 130 may be integrated into screen 110. For another embodiment, the screen controller 130 and the main controller 140 are hardwired together. For another embodiment, the screen controller 130 and the main controller 140 are wirelessly coupled (e.g., via an Infrared Data Association (IrDA) or BLUETOOTH interface) and can communicate via radio frequency (RF), infrared (IR), ultraviolet (UV), visible light signals, or other form of electromagnetic radiation or other wireless communication techniques, e.g., sonic signals. For some embodiments, screen controller 130 is integrated within main controller 140. For other embodiments, controller 130 is wirelessly (e.g., inductively) coupled to screen 110.

The main controller 140 is also connected between projector 120 and an image source 150, such as a VHS or DVD player or a set-top box connected to a direct television satellite link or a cable television provider, etc. For one embodiment, the main controller 140 may be integrated within projector 120 or may be integrated within image source 150. For another embodiment, a screen monitor 155, e.g., a camera, is hardwired or wirelessly coupled to or integrated within main controller 140 or is integrated into projector 120. For embodiments that include rear projection systems, screen monitor 155 may be located on the same side of screen 110 as projector 120 or on the opposite side of screen 110 so that it can receive images that are transmitted through screen 110.

For another embodiment, an ambient light sensor 160, such as a photodiode, photocell, or photo-transducer, is hardwired or wirelessly coupled to screen controller 130. Screen controller 130 and sensor 160 may wirelessly communicate, e.g., via radio frequency (RF), infrared (IR), ultraviolet (UV), or visible light signals. Screen controller 130 adjusts the darkness of screen 110 according to changes in the ambient lighting in response to sensor 160. For other embodiments, light sensor 160 may be integrated in screen controller 130 or main controller 140. For one embodiment, sensor 160 is integrated in screen 110 as one or more sensors, such as photodiodes, photocells, photo-transducers, etc. For other embodiments, sensor 160 is integrated in projector 120 or image source 150.

For another embodiment, main controller 140 is adapted to perform methods in accordance with embodiments of the present disclosure in response to computer-readable instructions. These computer-readable instructions are stored on a computer-usable media 170 of controller 140 and may be in the form of software, firmware, or hardware. In a hardware solution, the instructions are hard coded as part of a processor, e.g., an application-specific integrated circuit (ASIC) chip. In a software or firmware solution, the instructions are stored for retrieval by controller 140. Some additional examples of computer-usable media include static or dynamic random access memory (SRAM or DRAM), read-only memory (ROM), electrically-erasable programmable ROM (EEPROM or flash memory), magnetic media and optical media, whether permanent or removable. Many consumer-oriented computer applications are software solutions provided to the user on some removable computer-usable media, such as a compact disc read-only memory (CD-ROM).

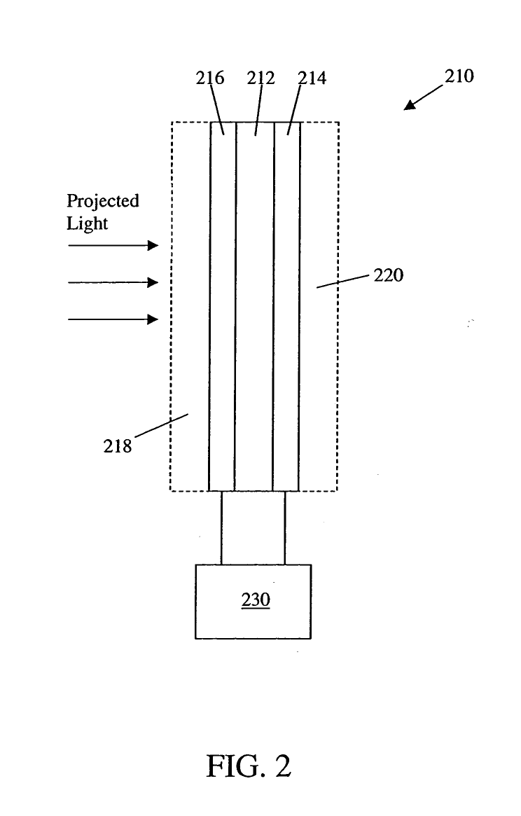

FIG. 2 is an enlarged cross-section of a portion of an active screen 210, according to another embodiment of the present disclosure. Screen 210 includes an active material, such as in one embodiment, active layer 212, sandwiched between electrodes, such as in one example embodiment, electrode layers 214 and 216. For one embodiment, active layer 212 is of an electrically controllable variable chromic material, such as doped liquid crystal (LC) material or electrochromic material, dyed electrochromic material, etc., that is responsive to different electrical field strengths provided by electrode layers 214 and 216. A material comprising tungsten oxide (WO₃), Lithium Perchlorate (LiClO₄), Propylene Carbonate (PC), and Polymethylmethacrylate (PMMA) is an example of a suitable electrochromic material, and Polymer Dispersed Liquid Crystal (PDLC) is an example of a suitable LC material. Other suitable variable chromic materials may be used.

For another embodiment, active layer 212 comprises a bi-stable material, such as electronic ink (E-Ink) available from E Ink corporation Cambridge, Mass., USA or Xerox, Palo Alto, Calif., USA. In such an embodiment, applying a first electrical field causes a change in the optical properties of the material, and the change persists even when the first electrical field is removed. The optical properties may be changed again by applying a second electric field (for example, an electric field with the same electric field strength as the first electric field, but applied in reverse). For another embodiment, a controller 230, such as a voltage or current controller, e.g., a voltage or current switch, is connected to electrode layers 214 and 216, e.g., for providing voltage differences across active layer 212 and thus different electric field strengths as suitable to control the intensity of the effect to obtain the proper image. Alternatively, one of electrode layers 214 or 216 is connected to ground. For one embodiment, controller 230 is wirelessly (e.g., inductively) coupled to one or both of electrode layers 214 and 216.

For one embodiment, electrode layers 214 and 216 include a conductive layer disposed on a substrate. For another embodiment, electrode layer 216 receives incoming projected light and is transparent. For example, the conductive layer may be a layer of Indium Tin Oxide and the substrate may be a transparent flexible plastic sheet, e.g., transparent Polyethylene Terephthalate (PET, PETE, or PETP) or polyimide. For one embodiment, active layer 212 is normally transparent and becomes more light absorbing, i.e., darker, in response to an electric field, the stronger the electric field the darker active layer 212. For this embodiment, electrode layer 214 is of a substantially diffusely reflective, e.g., white, material and therefore increasing the electric field strength makes the screen darker or more light absorbing. For another embodiment, active layer 212 is normally transparent and becomes more light reflecting, i.e., lighter, in response to an electric field, the stronger the electric field the more light reflecting active layer 212. For this embodiment, electrode layer 214 is of a substantially absorptive, e.g., black, material and therefore increasing the electric field strength makes the screen lighter or more reflective. In another embodiment, active layer 212 is normally reflective and becomes substantially absorptive in response to an electric field. In yet another embodiment, active layer 212 is normally absorptive and becomes substantially reflective in response to an electric field.

For one embodiment, a threshold value of the electric field strength applied to active layer 212 is crossed before changes in the optical properties of active layer 212 are detected, for example, with the naked eye of a human observer. For another embodiment, the optical properties of active layer 212 may change in the presence of an electric field and also in the presence of light (the latter being a photo-chromic effect). For this embodiment, the screen controller 130 sets the electric field strength to just below a threshold value, below which changes in the optical properties of the active layer 212 due to the electric field are not detectable with the naked eye by a human observer. At this point, light projected onto the screen causes the optical properties of the active layer 212 to change to the point where the optical property changes are detectable with the naked eye by a human observer. That is, the electric field biases active layer 212 to just below the threshold, below which changes in the optical properties of the active layer 212 are not at the point of being detectable with the naked eye, and the projected light brings the active layer 212 over this threshold, to the point where changes in the optical properties are detectable with the naked eye by a human observer.

For embodiments of rear projection systems, active layer 212 is normally transparent and becomes more light absorbing, i.e., darker, in response to an electric field. For these embodiments, both electrode layers 214 and 216 may be of a transparent conductive material, such as a layer of Indium Tin Oxide disposed on a transparent flexible plastic sheet. Alternatively, one of the electrode layers 214 and 216 may be semitransparent (or translucent). For one embodiment, optical layers 218 and 220 that are capable of focusing, redirecting, or diffusing light are disposed on electrode layers 214 and 216. For example, layer 218 may be a Fresnel layer, and layer 220 may be a lenticular layer.

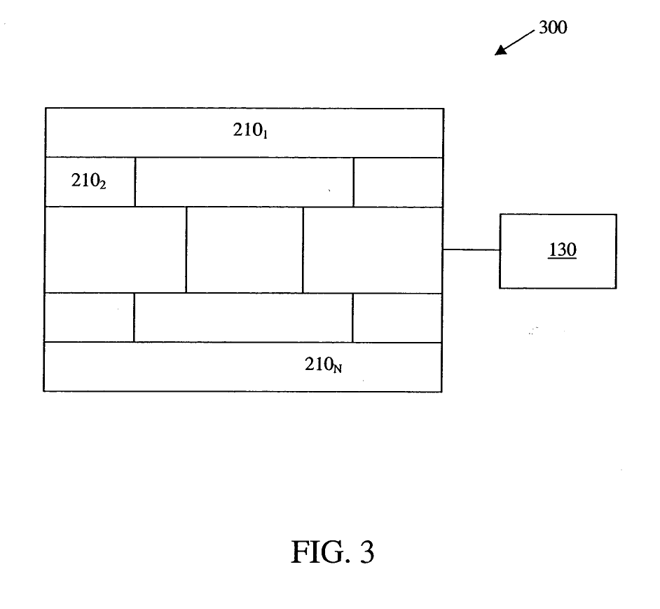

For one embodiment, controller 230 communicates directly with the main controller 140 of FIG. 1, as described for the screen controller 130 of FIG. 1. For this embodiment, screen 210 corresponds to an entire active projection screen, such as active screen 110 of FIG. 1, and controller 230 controls the entire screen. For another embodiment, screen 210 is a portion of an active screen, such as screen 300 of FIG. 3, that includes a plurality of screen portions 210 of different or equal sizes. Each screen portion 210 is connected to a controller 230 (not shown in FIG. 3). Each controller 230 is connected to the screen controller 130 and is individually controlled thereby in response to a control signal for each screen portion 210 received from the main controller 140 of FIG. 1. For another embodiment, each of portions 210 comprises a plurality of pixels or corresponds to a single pixel of an image projected onto screen 300. In another embodiment, each of the portions 210 is smaller in area than a single pixel of an image projected onto screen 300.

For one embodiment, main controller 140 sends one way signals to screen controller 130 for controlling the optical properties of an entire screen or each of screen portions 210, e.g., reflectance, absorbance, transmittance, darkness, color, etc. This may be performed on a frame-by-frame basis corresponding to the projector's frame presentation rate or scene-by-scene when there is not very much change from frame to frame. For some embodiments, the optical properties of the screen may be adjusted at a faster, slower, or about the same rate as the rate at which frames are projected onto the screen (frame speed). Alternatively, a buffering scheme may be used that enables a number of optical property values respectively corresponding to a number of frames to be pre-stored so that main controller 140 can instruct screen controller 130 to adjust the screen or each of screen portions 210 to an appropriate optical property value prior projecting a respective one of the frames onto the screen. For frontal projection embodiments, controlling the darkness of the screen or each of screen portions 210 controls the reflectance, whereas for rear projection embodiments, controlling the darkness of the screen or each of screen portions 210 controls the transmittance.

For one embodiment, main controller 140 analyzes image data, e.g., a bitmap, of each frame before that frame is projected to determine attributes of the image, such as contrast (or contrast ratio), darkness, etc. For one embodiment, this may involve looking at each pixel of the image data to determine the darkest and lightest pixels, and determining the contrast (or contrast ratio) from the darkest and lightest pixels. Alternatively, light pixels are averaged and dark pixels are averaged, and the contrast is determined from these averages. Contrasts can be determined in these ways for the entire frame that corresponds to the entire screen or for portions of the frame that respectively correspond to the screen portions 210. Main controller 140 then instructs screen controller 130 to adjust the voltage (and/or current) applied to the entire screen to give the appropriate contrast or to adjust the controllers 230 connected to the respective screen portions 210 for adjusting the voltages, for example, applied to those screen portions 210 to give the contrasts for those screen portions 210. For one embodiment, main controller 140 includes a look-up table that includes voltages versus one or more optical property values, a contrast, etc., and main controller 140 enters the table with one or more optical property values, a contrast, etc. determined from analyzing the image data and selects a corresponding voltage.

For another embodiment, main controller may look at portions of an image and set optical property values of the screen or screen portions 210 to pre-defined or user-defined optical property values. For some embodiments, monitor 155 may scan a test pattern projected onto the screen and main controller set the pre-defined optical property values in response to monitor 155. For another embodiment, the user may adjust the optical property values of the screen manually, e.g., via an adjustment knob of main controller 140, projector 120, screen controller 130, or image source 150.

For another embodiment, the contrast or optical properties of the screen are adjusted as described above. That is, the image data corresponding to the image is analyzed before it is projected to determine appropriate optical property values. The image is then projected on the screen. Monitor 155 receives the projected image reflected from or transmitted through the screen and sends it to main controller 140. Main controller 140 determines the optical property values from the pixels of image data corresponding to the reflected image, as described above, and compares these optical property values to the determined optical property values of the image data of the image before it was projected to determine if the optical property values are correct. If the optical property values are within acceptable limits of each other, nothing is done. Otherwise, main controller 140 updates the optical property values and the process is repeated. That is, monitor receives an updated image from the screen, determines the optical property values thereof, and either accepts the updated optical property values or readjusts the optical property values, and the process proceeds iteratively until acceptable optical property values are achieved.

For one embodiment, regions of screen portions 210 adjacent the boundaries of screen portions 210 that can be smaller than, larger than, or about the size of the pixels of the projected image are active. That is, each of these regions is connected to a controller 230 that is connected to screen controller 130, as is the screen portion 210. Main controller 140 analyzes the bitmap of the reflected or transmitted image received from monitor 155, and instructs screen controller 130 to adjust the regions adjacent the boundaries of screen portions 210 to blend the edges for removing or at least substantially reducing any lines between the screen portions 210. This can be done using an iterative process until the lines are removed.

For embodiments where screen portions 210 are active and whose optical properties are capable of independent adjustment, some type of an alignment scheme may be useful for aligning the projected image with the screen portions 210. For one embodiment, this may include in-situ alignment using monitor 155, for example, or pre-alignment, e.g., at a manufacturing facility.

### CONCLUSION

Although specific embodiments have been illustrated and described herein it is manifestly intended that this present disclosure be limited only by the following claims and equivalents thereof.

What is claimed is:

1. A screen comprising:
active material, having at least one optical property responsive to an electric field, disposed between electrodes; and
a controller coupled to at least one of the electrodes for controlling the electric field in response to a signal received by the controller.

2. The screen of claim 1, wherein the active material is normally transparent and becomes more light absorbing or more reflective in response to the electric field.

3. The screen of claim 1, wherein the active material is substantially light absorbing and becomes more light reflective in response to the electric field.

4. The screen of claim 1, wherein the active material is substantially light reflecting and becomes more light absorbing in response to the electric field.

5. The screen of claim 1, wherein the electrodes are selected from the group consisting of one or more of the electrodes is transparent, one of the electrodes is transparent and another is translucent, one of the electrodes is transparent and another is of a light absorbing material, and one of the electrodes is transparent and another is a reflector or a diffuse reflector.

6. The screen of claim 1, wherein the signal is based on an ambient light level, a user input, or on a property of a projected image.

7. The screen of claim 1, wherein the controller is connectable to a projector.

8. The screen of claim 1, with the controller corresponding to a first controller, further comprising a second controller connectable between an image source and a projector and wirelessly connected or hardwired to the first controller.

9. The screen of claim 1, wherein the screen is a rear projection screen.

10. The screen of claim 9, wherein the electrodes are sandwiched between optical layers configured to perform one or more of focusing, redirecting, or diffusing light.

11. The screen of claim 1, wherein the screen is a frontal projection screen.

12. The screen of claim 1, wherein the at least one optical property of the active material is further responsive to light from a projected image incident upon the active material.

13. The screen of claim 12, wherein the electric field acts to bias the active material to just below a threshold and the light acts to bring the active layer over this threshold.

14. The screen of claim 1, wherein the controller is wirelessly coupled to at least one of the electrodes.

15. The screen of claim 1, wherein the controller and the electrodes are configured to establish the electric field through application of a voltage and/or current to at least one of the electrodes.

16. The screen of claim 1, wherein the active material is selected from the group consisting of an electrically controllable variable chromic material, a doped liquid crystal material, an electrochromic material, a dyed electrochromic material, a bi-stable material, and electronic ink.

17. The screen of claim 1, wherein the active material disposed between electrodes forms one screen portion of a plurality screen portions, each having the active material disposed between electrodes.

18. The screen of claim 17, wherein the controller is one of a plurality of controllers, the controllers coupled one to one to at least one of the electrodes of the plurality of screen portions.

19. The screen of claim 1, wherein the screen is configured to measure ambient light and adjusts the optical properties based upon this light.

20. The screen of claim 1, wherein the at least one optical property of the active material changes based upon projected light incident upon the active material and the electric field.

21. A projection screen comprising:
a plurality of screen portions, each screen portion comprising an active layer disposed between a pair of electrode layers, wherein at least one optical property of each of the active layer is responsive to an electric field produced by its corresponding electrode layers; and
a plurality of controllers, the controllers respectively coupled to at least one of the electrode layers of the pairs of electrode layers, each controller for controlling the electric field produced by its corresponding pair of electrode layers in response to a control signal received by that controller.

22. The projection screen of claim 21, wherein each of the screen portions is about the size a pixel of an image projected onto the projection screen or is smaller than a pixel of an image projected onto the projection screen.

23. The projection screen of claim 21, wherein each active layer is normally transparent and becomes more light absorbing or more light reflecting in response to the electric field.

24. The projection screen of claim 21 further comprises a screen controller connected to each of the controllers.

25. The projection screen of claim 24 further comprises a main controller connectable between an image source and a projector and wirelessly connected or hardwired to the screen controller.

26. The projection screen of claim 21, wherein each of the controllers is connectable to a projector.

27. A projection screen comprising:
a means for receiving a projected image;
a means for receiving a control signal that does not include an image to be projected on the screen; and
a means for adjusting one or more optical properties of one or more portions of the screen that is responsive to the means for receiving a control signal.

28. The projection screen of claim 27 further comprises a means for generating the control signal in response to an ambient light level.

29. The projection screen of claim 27 further comprises a means for determining one or more optical property values that correspond to the one or more optical properties of the one or more portions of the screen from image data corresponding to the image and for generating the control signal, wherein the control signal is based on the one or more optical property values.

30. A method of operating a screen, comprising:
adjusting one or more optical properties of the screen using one or more controllers to adjust an electric field applied to an active material according to a signal.

31. The method of claim 30, wherein the signal is based at least one of an ambient light level, a property of an image to be projected onto the screen, or content of an image to be projected onto the screen.

32. The method of claim 30, wherein adjusting one or more optical properties comprises adjusting one or more optical properties of one or more portions of the screen.

33. The method of claim 30, wherein the control signal is based one or more optical property values of image data corresponding to an image to be projected on the screen.

34. A method of operating a screen, comprising:
determining one or more optical property values for one or more portions of an image using image data; and
adjusting one or more optical properties of one or more portions of the screen corresponding to the one or more portions of the image by adjusting an electric field applied to active material of the one or more portions of the screen using the one or more optical property values.

35. The method of claim 34, wherein determining one or more optical property values for one or more portions of the image comprises using lightest and darkest pixels of the image data.

36. The method of claim 34, wherein determining one or more optical property values for one or more portions of the image further comprises averaging light and dark pixels of the image data and determining a contrast from the averaged light and dark pixels.

37. The method of claim 34 further comprises receiving the image data from an image source.

38. The method of claim 34, wherein the one portion of the screen is the entire screen.

39. The method of claim 34, wherein adjusting one or more optical properties of one or more portions of the screen comprises adjusting the electric field to bias the active layer to below a threshold and projecting light onto the one or more portions of the screen to bring the active material of the one or more portions of the screen over this threshold.

40. The method of claim 34, wherein determining one or more optical property values comprises analyzing the image data.

41. The method of claim 34, wherein adjusting one or more optical properties of one or more portions of the screen by adjusting the electric field applied to active material of the one or more portions of the screen comprises measuring light from the screen and then adjusting the electric field based on a difference between a desired level of the light and a measured level of the light.

42. The method of claim 34 further comprises substantially reducing any lines between the one or more screen portions.

43. The method of claim 42, wherein substantially reducing any lines between the one or more screen portions comprises adjusting regions adjacent boundaries of the one or more screen portions by adjusting an electric field applied to active material of the regions using one or more optical property values of the regions based on the image data.

44. The method of claim 34, wherein adjusting one or more optical properties comprises independently adjusting the electric field applied to the active material of the one or more portions of the screen.

45. The method of claim 34, wherein the one or more portions of the screen are about the size a pixel of an image projected onto the projection screen or are smaller than a pixel of the image.

46. A method of operating an active projection screen, comprising:
analyzing first image data corresponding to an image to be projected onto the screen for determining one or more image property values for one or more portions of the image;
sending a first control signal to one or more controllers of the screen that is indicative of the determined one or more image property values;
adjusting one or more image properties of one or more portions of the screen corresponding to the one or more portions of the image according to the determined one or more image property values using the one or more controllers to adjust an electric field applied to an active layer of the one or more portions of the screen in response to the first control signal;
projecting the image onto the screen;
monitoring the projected image to determine whether values of one or more image properties of the one or more portions of the screen are at the determined one or more image property values; and
readjusting the one or more image properties of the one or more portions of the screen if the values of one or more image properties of the one or more portions of the screen are not at the determined one or more image property values.

47. The method of claim 46 further comprises receiving the first image data from an image source.

48. The method of claim 46, wherein monitoring the projected image further comprises:
receiving second image data corresponding to the projected image;
analyzing the second image data for determining one or more image property values for one or more portions of the projected image corresponding to the one or more portions of the screen; and
comparing the one or more image property values for one or more portions of the projected image to the one or more image property values of the corresponding one or more portions of the image to be projected onto the screen.

49. A controller for a screen to perform a method comprising:
analyzing image data of an image to be projected onto the screen for determining one or more optical property values for one or more portions of the image; and
sending a signal to one or more controllers of the screen that is indicative of the one or more optical property values, wherein the signal instructs the one or more controllers to adjust one or more optical properties of one or more portions of the screen corresponding to the one or more portions of the image according to the determined one or more optical property values.

50. The controller of claim 49, wherein the method further comprises receiving the image data from an image source.

51. The controller of claim 49, wherein the controller is integrated within a projector or an image source.

52. The controller of claim 49 further comprises a monitor for monitoring the image after it is projected onto the screen.

53. The controller of claim 49, wherein the method further comprises:
monitoring the image after it is projected onto the screen to determine whether one or more optical property values of the one or more portions of the screen are at the determined one or more optical property values; and
readjusting the one or more optical property values of the one or more portions of the screen if the one or more optical property values of the one or more portions of the screen are not at the determined one or more optical property values.

54. A computer-usable medium containing computer-readable instructions for performing a method of operating a screen, comprising:
determining one or more optical property values for one or more portions of an image using image data; and
adjusting one or more optical properties of one or more portions of the screen corresponding to the one or more portions of the image by adjusting an electric field applied to active material of the one or more portions of the screen using the one or more optical property values.

55. The computer-usable medium of claim 54, wherein, in the method, determining one or more optical property values for one or more portions of the image comprises using lightest and darkest pixels of the image data.

56. The computer-usable medium of claim 54, wherein, in the method, determining one or more optical property values for one or more portions of the image further comprises averaging light and dark pixels of the image data and determining a contrast from the averaged light and dark pixels.

57. The computer-usable medium of claim 54, wherein the method further comprises receiving the image data from an image source.

58. The computer-usable medium of claim 54, wherein, in the method, the one portion of the screen is the entire screen.

59. The computer-usable medium of claim 54, wherein, in the method, adjusting one or more optical properties of one or more portions of the screen comprises adjusting the electric field to bias the active layer to below a threshold and projecting light onto the one or more portions of the screen to bring the active material of the one or more portions of the screen over this threshold.

60. The computer-usable medium of claim 54, wherein, in the method, determining one or more optical property values comprises analyzing the image data.

61. The computer-usable medium of claim 54, wherein, in the method, adjusting one or more optical properties of one or more portions of the screen by adjusting the electric field applied to active material of the one or more portions of the screen comprises measuring light from the screen and then adjusting the electric field based on a difference between a desired level of the light and a measured level of the light.

62. The computer-usable medium of claim 54, wherein the method further comprises substantially reducing any lines between the one or more screen portions.

63. The computer-usable medium of claim 62, wherein, in the method, substantially reducing any lines between the one or more screen portions comprises adjusting regions adjacent boundaries of the one or more screen portions by adjusting an electric field applied to active material of the regions using one or more optical property values of the regions based on the image data.

64. The computer-usable medium of claim 54, wherein, in the method, adjusting one or more optical properties comprises independently adjusting the electric field applied to the active material of the one or more portions of the screen.

65. The computer-usable medium of claim 54, wherein, in the method, the one or more portions of the screen are about the size a pixel of an image projected onto the projection screen or are smaller than a pixel of the image.

66. A display system comprising:
a screen comprising:
active material, having at least one optical property responsive to an electric field, disposed between electrodes; and
a controller coupled to at least one of the electrodes for controlling the electric field in response to a signal received by the controller; and
a projector.

67. The display system of claim 66, with the controller corresponding to a first controller, the display system further comprises a second controller coupled to the first controller.

68. The display system of claim 67, wherein the second controller is further coupled to the projector.

69. The display system of claim 67, wherein the second controller is integrated into the projector.

70. The display system of claim 67 further comprises an image source coupled to the second controller.

71. The display system of claim 70, wherein the second controller is integrated into the image source or the projector.

72. The display system of claim 67 further comprises a screen monitor coupled to the second controller.

73. The display system of claim 66 further comprises an ambient light sensor coupled to the controller.

74. The display system of claim 66 further comprises an image source coupled to the projector.
